(19) United States
(12) Patent Application Publication
(10) Pub. No.: US 2011/0161126 A1
(43) Pub. Date: Jun. 30, 2011

(54) RESOURCE FREE TIME REPORTING IN A TASK MANAGEMENT SYSTEM

(75) Inventors: Steven F. Best, Westford, MA (US); Janice M. Girouard, Austin, TX (US)

(73) Assignee: INTERNATIONAL BUSINESS MACHINES CORPORATION, Armonk, NY (US)

(21) Appl. No.: 12/647,770

(22) Filed: Dec. 28, 2009

(51) Int. Cl. G06Q 10/00

(52) U.S. Cl. 705/7.13

(57) ABSTRACT

The reporting of the free time for the resources of a task management system can begin with a free time reporter receiving an identifier of a resource registered with a task management system and a time period from a graphical user interface (GUI) of the task management system. The time period can be defined by a start date and an end date or a total quantity of time. For each resource, time allocation data can be queried to determine the quantity of time the resource is allocated to existing task activities during the time period. A free time report can then be generated based upon the queried data. The free time report can then be presented within the GUI of the task management system.

### BACKGROUND

The present invention relates to the field of task management systems and, more particularly, to the reporting of free time for resources of a task management system.

Task management systems are vital tools utilized throughout the computing world. These task management systems range from complex and detailed project management systems to the simple “To-Do List” components of email systems. Particularly, task management systems allow users to assign resources, human and otherwise, to their various task activities. However, when assigning resources to a task activity, it is difficult for a user to gauge the likelihood that a resource will be able to complete the task.

To address this problem, many task management systems include a variety of data analysis reports and tools such as Gantt charts. However, these reports often require additional time to generate and provide a level of detail that is unnecessary to the user. For example, a Gantt chart presents a chronological listing of all the task activities involved in a specific project. However, a user cannot quickly determine from the Gantt chart if a specific resource has enough free time to complete a new task activity.

### BRIEF SUMMARY

One aspect of the present invention can include a method for the reporting of free time for resources of a task management system. Such a method can begin with a free time reporter receiving an identifier of a resource registered with a task management system and a time period from a graphical user interface (GUI) of the task management system. The time period can be defined by a start date and an end date or a total quantity of time. For each resource, time allocation data can be queried to determine the quantity of time the resource is allocated to existing task activities during the time period. A free time report can then be generated based upon the queried data. The free time report can then be presented within the GUI of the task management system.

Another aspect of the present invention can include a task management system that reports the free time of resources. Such a task management system can include time allocation data, a graphical user interface (GUI), and a free time reporter. The time allocation data can define the quantity of time that a resource is allocated to existing task activities. The GUI can be configured to provide an interaction mechanism for capturing and presenting time allocation data and task activities. The free time reporter can be configured to present within the GUI a free time report describing the quantity of free time for each resource assigned to the task activity displayed by the GUI. The quantity of free time can represent the time that the resource is unassigned to existing task activities within the time period defined for the task activity.

Yet another aspect of the present invention can include a computer program product that includes a computer readable storage medium having embedded computer usable program code. The computer usable program code can be configured to receive an identifier of a resource registered with the task management system and a time period. The time period can be defined by a start date and an end date or a total quantity of time. The computer usable program code can be configured to, for each resource, query time allocation data for the quantity of time that the resource is allocated to existing task activities during the time period. The computer usable program code can then be configured to generate a free time report based upon the queried data. The computer usable program code can be configured to present the free time report within the graphical user interface (GUI) of the task management system.

### BRIEF DESCRIPTION OF THE SEVERAL VIEWS OF THE DRAWINGS

FIG. 1 is a schematic diagram illustrating a system that can present the amount of free time for the resources of a task management system in accordance with embodiments of the inventive arrangements disclosed herein.

FIG. 2 is a component diagram of a legal matter management application in accordance with an embodiment of the inventive arrangements disclosed herein.

FIG. 3 is a collection of user interface windows that illustrate presentation of the free time report in accordance with an embodiment of the inventive arrangements disclosed herein.

### DETAILED DESCRIPTION

The present invention discloses a solution for presenting the amount of free time of resources assigned to a task activity within a task management system. A user can have the option of viewing a free time report for the resources of a task activity within the user interface of a task management system. The free time report can be generated by a free time reporter that can query the time allocation data of the task management system to determine the amount of free time for each resource. The free time report can be presented within a free time report window and can include user-selectable options for viewing the data of the free time report.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

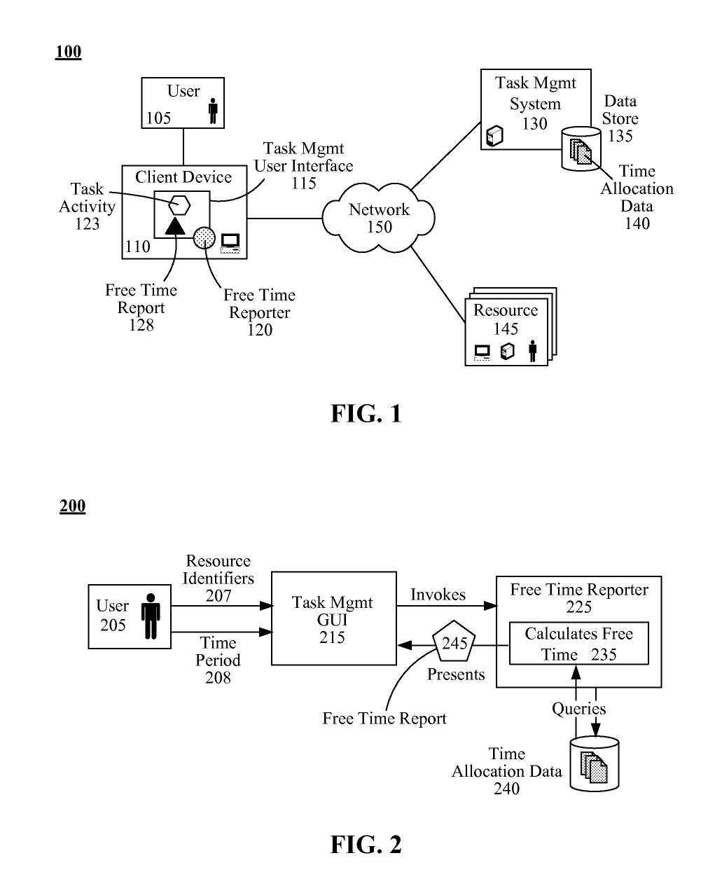

FIG. 1 is a schematic diagram illustrating a system 100 that can present the amount of free time for the resources 145 of a task management system 130 in accordance with embodiments of the inventive arrangements disclosed herein. In system 100, a user 105 can view a free time report 128 pertaining to the resources 145 associated with a task activity 123 presented within the task management user interface 115 of a task management system 130.

As used herein, the term “free time” is defined as time that a resource 145 is not assigned to existing task activities 123 within the task management system 130. That is, free time can be readily assigned to new task activities 123.

The task management system 130 can represent the hardware and/or software for a computing system capable of handling the allocation of resources 145 to various task activities 123. The task management system 130 can be a stand-alone software system such as a project management system, or an integrated component of a larger communications system, such as an email system that includes calendar and task functions.

Information regarding such allocations can be captured by the task management system 130 as time allocation data 140 within an associated data store 135. The time allocation data 140 can capture the quantity of time a resource 145 is allocated to a specific task activity 123. For example, an administrative assistant 145 can be allotted three days to schedule a conference call by a supervisor 105.

It should be noted that the data store 135 can include additional information regarding the various task activities 123, and that any additional information can be integrated or associated with the time allocation data 140, which can represent a specific subset of data that is of particular relevance to the free time reporter 120 and/or free time report 128.

Resources 145 can represent human and/or mechanical entities registered with the task management system 130. In the case of mechanical resources 145, a human resource 145 can be assigned to act as a responsible party for completing or overseeing the task activity 123.

The task management system 130 can also include a task management user interface 115 that provides a user 105 with the ability to perform various functions such as creating/viewing/modifying task activities 123. The task management user interface 115 can be configured to operate upon a client device 110 and communicate with the task management system 130 over a network 150.

Additionally, the task management user interface 115 can include a free time reporter 120 configured to generate and present a free time report 128 for the resources 145 that are associated with a displayed task activity 123. The free time reporter 120 can utilize data elements of the task activity 123 such as resource 145 identifiers to query the time allocation data 140 of the task management system 130. The free time report 128 can be created from the queried data and presented within the task management user interface 115.

When generating the free time report 128, the free time reporter 120 can be configured to utilize a set of user-configurable business rules (not shown) that define business-specific conditions, such as the length of a work day, work shift hours for resources 145, and days when the business is closed (i.e., weekends and holidays). The user-configurable business rules can be stored within the task management system 130.

In another embodiment, the free time reporter 120 can operate from the task management system 130 and communicate the free time report 128 to the task management user interface 115 over the network 150.

The free time report 128 can present the user 105 with real-time data regarding the free time available for a resource 145. The data can be presented within the free time report 128 in a variety of ways, such as a percentage or a quantity of hours. Additionally, the presentation of the free time report 128 within the task management user interface 115 can include user-selectable options for changing how the data is presented.

It is important to note that the free time report 128 can provide the user 105 with a simple and time-saving means for estimating the completion of a task activity 123 that is currently lacking from conventional task management systems 130. For example, when creating a new task activity 123, the user 105 can view the free time report 128 and see the amount of free time each resource 145 has available, as recorded within the task management system 130. From the free time information contained within the free time report 128, the user 105 can then estimate the likelihood that the assigned resource 145 will be able to complete the task activity 123 (e.g., the task requires four hours of work and the resource 145 has five hours of free time). This can allow the user 105 to modify elements of the task activity 123, such as the assigned resources 145 or task dates, to ensure a better probability of completion before assigning the task activity 123.

It should also be noted that the free time report 128 differs from the various data analysis reports such as Gantt charts produced by many conventional task management systems 130. Firstly, many of these data analysis reports require complex and/or detailed tasking information to be captured within the task management system 130. The free time reporter 120 can be utilized with simpler task management systems 130 such as “To-Do Lists”, provided the system 130 captures the necessary time allocation data 140. Further, the free time report 128 can provide a simple quantity of free time without additional charts or requiring the user 105 to understand how to read the data.

Network 150 can include any hardware/software/and firmware necessary to convey data encoded within carrier waves. Data can be contained within analog or digital signals and conveyed though data or voice channels. Network 150 can include local components and data pathways necessary for communications to be exchanged among computing device components and between integrated device components and peripheral devices. Network 150 can also include network equipment, such as routers, data lines, hubs, and intermediary servers which together form a data network, such as the Internet. Network 150 can also include circuit-based communication components and mobile communication components, such as telephony switches, modems, cellular communication towers, and the like. Network 150 can include line based and/or wireless communication pathways.

As used herein, presented data store 135 can be a physical or virtual storage space configured to store digital information. Data store 135 can be physically implemented within any type of hardware including, but not limited to, a magnetic disk, an optical disk, a semiconductor memory, a digitally encoded plastic memory, a holographic memory, or any other recording medium. Data store 135 can be a stand-alone storage unit as well as a storage unit formed from a plurality of physical devices. Additionally, information can be stored within data store 135 in a variety of manners. For example, information can be stored within a database structure or can be stored within one or more files of a file storage system, where each file may or may not be indexed for information searching purposes. Further, data store 135 can utilize one or more encryption mechanisms to protect stored information from unauthorized access.

FIG. 2 is an illustrated flow diagram 200 for generating a free time report 245 in accordance with embodiments of the inventive arrangements disclosed herein. Flow diagram 200 can be utilized within the context of system 100 or any other task management system supporting operation of a free time reporter.

In flow diagram 200, the user 205 can provide resource identifiers 207 and a time period 208 within the task management graphical user interface (GUI) 215. The user 205 can provide this information 207 and 208 by performing such actions as creating a new task activity or viewing/modifying an existing task activity, such as the task activities 123 of system 100.

The resource identifiers 207 can correspond to entities registered within the task management system associated with the task management GUI 215. The time period 208 can represent the quantity of time allowed for completion of the task activity. The time period 208 can be expressed within the task management GUI 215 in a variety of ways, and should include a combination of a start date, an end date, and a quantity of time.

For example, the time period 208 can be expressed as starting on Monday, Nov. 30, 2009 and lasting three days. An alternate representation of this time period 208 can be expressed as a start date of Monday, Nov. 30, 2009 and an end date of Wednesday, Dec. 2, 2009. The time period 208 can be further expanded to include specific time information in addition to dates.

From the task management GUI 215, the free time reporter 225 can be invoked. Invocation of the free time reporter 225 can require the selection of an option or command from within the task management GUI 215 or can be automatically initiated by the task management GUI 215 in response to other programmatic actions.

With the resource identifiers 207 and time period 208 passed by the task management GUI 215, the free time reporter 225 can query the time allocation data 240. Then, the free time reporter 225 can calculate the amount of free time 235 for each resource identifier 207 within the time period 208.

For example, the calculation of free time 235 can require the free time reporter 120 to determine the total amount of time defined by the time period 208 and the total amount of time that each resource is assigned to existing task activities 123 during the time period 208. The difference between these two quantities can represent the amount of free time for the resource identifier 207.

Once the free time is calculated 235 for each resource identifier 207, the free time report 245 can be presented within the task management GUI 215.

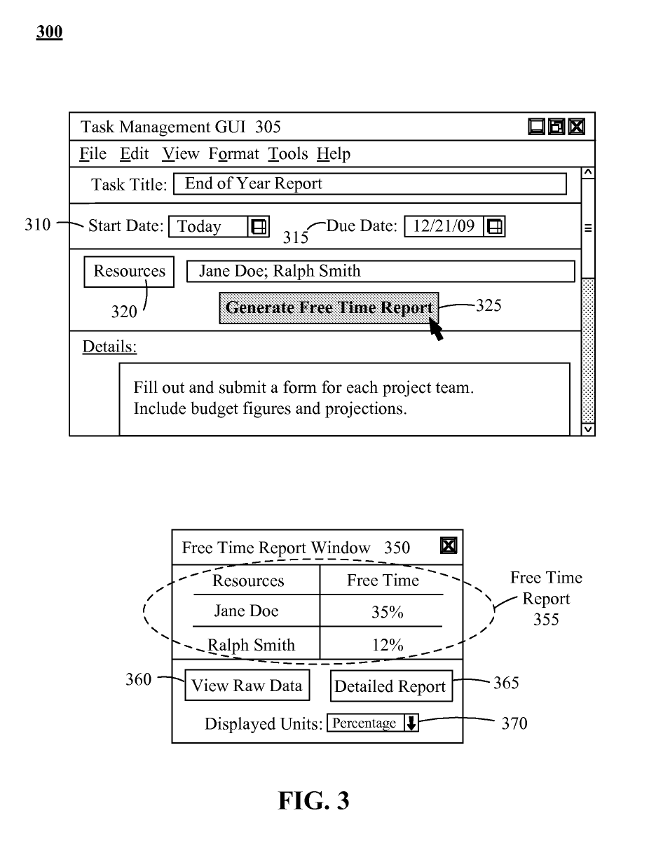

FIG. 3 is a collection 300 of user interface windows 305 and 350 that illustrate presentation of the free time report 355 in accordance with embodiments of the inventive arrangements disclosed herein. The user interface windows 305 and 350 of collection 300 can be utilized within the context of system 100 and/or flow diagram 200.

It should be noted that the user interface windows 305 and 350 of collection 300 are for illustrative purposes only, and are not meant to imply an absolute implementation or limitation of an embodiment of the present invention.

Collection 300 can include a task management GUI 305 and a free time report window 350. The task management GUI 305 can correspond to the software interface utilized by a user of the associated task management system, such as the task management user interface 115 of system 100.

The task management GUI 305 can be configured to capture a variety of data for the task management system. As shown in this example, the data fields within the task management GUI 305 of particular importance for operation of the free time reporter can include the start date 310, due date 315, and resources 320. It should be noted that the configuration and/or capture of the data for these data fields 310-320 can vary based upon the task management system.

The task management GUI 305 can also include user-selectable a free time report button 325. Selection of the free time report button 325 can invoke the free time reporter and result in the presentation of the free time report window 350.

The free time report window 350 can represent a secondary window of the task management GUI 305 designed to present the free time report 355. As shown in this example, the free time report 355 can list each resource 320 designated in the task management GUI 305 with a calculated free time value.

The free time report window 350 can be further expanded to include user-selectable operations of value to the user such as a view raw data button 360, a detailed report button 365, and a displayed units selector 370.

Selection of the view raw data button 360 can present the user with the raw data used by the free time reporter to determine the free time of each resource 320. Depending upon the implementation, the view raw data button 360 can display the raw data within the free time report window 350, discarding the free time report 355, or can launch a new window (not shown) for presentation.

Selection of the detailed report button 365 can present the user with a more detailed version of the free time report 355. For example, the contents of the free time report 355 can be replaced with a listing of task activities and the amount of time each resource 320 is allocated. Alternately, this information can be presented in a chart format, such as a pie chart.

The displayed units selector 370 can allow the user to change the units in which the free time is presented within the free time report 355. As shown in this example, “Percentage” is selected for the displayed units selector 370 and the free time is presented within the free time report 355 as a percentage with respect to the time period of the task activity. Other selections for the displayed units selector 370 can include hours, days, and the like.

In another contemplated embodiment, the contents of the free time report 355 can be displayed directly within the task management GUI 305. For example, the task management GUI 305 can include a specific area that can dynamically display the contents of the free time report 355.

In an alternate embodiment, the contents of the free time report 355 can be displayed in a pop-up window when the user places the mouse pointer over a resource 320. Such an embodiment would not require a free time report button 325; invocation of the free time reporter would occur automatically in response to the location of the mouse pointer.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for the reporting of free time for resources of a task management system comprising:
receiving, by a receiving unit, of at least one identifier of a resource registered with a task management system and a time period by a free time reporter from a graphical user interface (GUI) of the task management system, wherein the time period is defined by a start date and at least one of an end date and a total quantity of time;
for each resource, querying, by a querying unit, a plurality of time allocation data for a quantity of time the resource is allocated to existing task activities during the time period;
generating, by a generation unit, a free time report based upon the queried data; and
presenting, by a presentation unit, the free time report within the GUI of the task management system.

2. The method of claim 1, wherein the generation of the free time report further comprises:
determining, by a determination unit, a total quantity of time defined by the time period; and
calculating, by a calculation unit, a quantity of free time for each resource, wherein said quantity of free time is defined as a difference between the total quantity of time defined by the time period and the quantity of time the resource is allocated to existing task activities.

3. The method of claim 2, wherein the determination of the total quantity of time defined by the time period further comprises:
adjusting, by an adjusting unit, the total quantity of time defined by the time period to account for at least one of predefined work hours of the resource, scheduled business closures, a predefined work day, and system-defined calculation rules, wherein the scheduled business closures comprise at least one of a holiday, a shutdown, and a day off.

4. The method of claim 2, wherein the quantity of free time is expressed as at least one of a percentage of the total quantity of time defined by the time period and a total quantity of hours.

5. The method of claim 1, wherein the receipt of the at least one identifier of the resource and the time period is performed in response to a user-selected command made within the GUI of the task management system.

6. The method of claim 1, wherein presentation of the free time repost comprises at least one user-selectable viewing option for data comprising the free time report, wherein the at least one user-selectable viewing option comprises at least one of a view detailed report option, a view raw data option, and a change displayed free time units options.

7. The method of claim 6, further comprising:
in response to selection of a user-selectable viewing option, dynamically modifying, by a modifying unit, the presentation of data within the free time report.

8. The method of claim 1, wherein the presentation of the free time report utilizes a free time report window that is an independent element of the GUI of the task management system.

9. A task management system that reports the free time of resources comprising:
a plurality of time allocation data defining a quantity of time that a resource is allocated to existing task activities;
a graphical user interface (GUI) configured to provide an interaction mechanism for capturing and presenting the plurality of time allocation data and task activities; and
a free time reporter configured to present within the GUI a free time report describing a quantity of free time for each resource assigned to a task activity displayed by the GUI, wherein said quantity of free time represents time the resource is unassigned to existing task activities within a time period defined for the task activity.

10. The task management system of claim 9, wherein the quantity of free time is expressed as at least one of a percentage of a total quantity of time defined by the time period and a total quantity of hours.

11. The task management system of claim 9, wherein the GUI further comprises:
a free time report window for displaying the free time report, wherein the free time report window is an independent element of the GUI.

12. The task management system of claim 11, wherein the free time report window further comprises:
at least one user-selectable viewing option for data comprising the free time report, wherein the at least one user-selectable viewing option comprises at least one of a view detailed report option, a view raw data option, and a change displayed free time units options.

13. The task management system of claim 12, wherein selection of a user-selectable viewing option dynamically modifies the free time report within the free time report window.

14. A computer program product comprising a computer readable storage medium having computer usable program code embodied therewith, the computer usable program code comprising:
computer usable program code stored in a tangible medium configured to receive at least one identifier of a resource registered with a task management system and a time period, wherein the time period is defined by a start date and at least one of an end date and a total quantity of time;
computer usable program code stored in a tangible medium configured to, for each resource, query a plurality of time allocation data for a quantity of time the resource is allocated to existing task activities during the time period;
computer usable program code configured to generate a free time report based upon the queried data; and
computer usable program code stored in a tangible medium configured to present the free time report within a graphical user interface (GUI) of the task management system.

15. The computer program product of claim 14, wherein the quantity of free time is expressed as at least one of a percentage of a total quantity of time defined by the time period and a total quantity of hours.

16. The computer program product of claim 14, wherein the generation of the free time report further comprises:
computer usable program code stored in a tangible medium configured to determine a total quantity of time defined by the time period; and
computer usable program code stored in a tangible medium configured to calculate a quantity of free time for each resource, wherein said quantity of free time is defined as a difference between the total quantity of time defined by the time period and the quantity of time the resource is allocated to existing task activities.

17. The computer program product of claim 16, wherein the determination of the total quantity of time defined by the time period further comprises:
computer usable program code stored in a tangible medium configured to adjust the total quantity of time defined by the time period to account for at least one of predefined work hours of the resource, scheduled business closures, a predefined work day, and system-defined calculation rules, wherein the scheduled business closures comprise at least one of a holiday, a shutdown, and a day off.

18. The computer program product of claim 14, wherein presentation of the free time repost comprises at least one user-selectable viewing option for data comprising the free time report, wherein the at least one user-selectable viewing option comprises at least one of a view detailed report option, a view raw data option, and a change displayed free time units options.

19. The computer program product of claim 18, further comprising:
computer usable program code stored in a tangible medium configured to, in response to selection of a user-selectable viewing option, dynamically modify the presentation of data within the free time report.

20. The computer program product of claim 14, wherein the receipt of the at least one identifier of the resource and the time period is performed in response to a user-selected command made within the GUI of the task management system.
